(19) United States
(12) Patent Application Publication
(10) Pub. No.: US 2021/0122252 A1
(43) Pub. Date: Apr. 29, 2021

(54) SERVICABLE ELECTRIC VEHICLE BATTERY ENCLOSURE

(71) Applicant: GM Global Technology Operations LLC, Detroit, MI (US)

(72) Inventor: Charles W. Toohy, Waterford, MI (US)

(21) Appl. No.: 16/661,652

(22) Filed: Oct. 23, 2019

(51) Int. Cl. B60L 50/60; B60K 1/04; H01M 2/10

(52) U.S. Cl. CPC B60L 50/66; B60K 1/04; H01M 2220/20; H01M 2/1083; H01M 2/1077

(57) ABSTRACT

An electric vehicle battery enclosure includes a base portion to hold one or more batteries that provide motive power to an all-electric or hybrid electric vehicle, and a cover portion to mate with the base portion to enclose the one or more batteries. The enclosure also includes a sealant to create a seal between the base portion and the cover portion around a perimeter of the enclosure, and a cord to break through the sealant to open the enclosure.

### INTRODUCTION

The subject disclosure relates to a serviceable electric vehicle battery enclosure.

Electric-vehicle batteries (EVBs), also referred to as traction batteries, provide motive power in all-electric or hybrid electric vehicles. EVBs differ from batteries used by other vehicle systems (e.g., starting, lighting, ignition) because they are designed to power the vehicle for sustained periods of time. The EVBs are a pack of two or more batteries (e.g., lithium-ion batteries), each of which may include several hundred individual battery cells. EVBs may be packaged together with temperature, voltage, and current sensors. During use, the EVBs must be stored in a sealed enclosure to protect the battery cells from damage and debris and to contain the heat and gasses produced by the EVBs. However, while a secure seal is desirable during use, it may present challenges when one or more batteries or other components in the enclosure need to be serviced. Accordingly, it is desirable to provide a serviceable electric vehicle battery enclosure.

### SUMMARY

In one exemplary embodiment, an electric vehicle battery enclosure includes a base portion to hold one or more batteries that provide motive power to an all-electric or hybrid electric vehicle, and a cover portion to mate with the base portion to enclose the one or more batteries. The enclosure also includes a sealant to create a seal between the base portion and the cover portion around a perimeter of the enclosure, and a cord to break through the sealant to open the enclosure.

In addition to one or more of the features described herein, the enclosure also included one or more anchor points configured to anchor the cord to the enclosure.

In addition to one or more of the features described herein, the cord is arranged parallel to the sealant and closer to an interior of the base portion than the sealant.

In addition to one or more of the features described herein, a portion of the cord extends outside the enclosure.

In addition to one or more of the features described herein, the cord is a nylon wire.

In addition to one or more of the features described herein, the cord is a flexible steel wire.

In addition to one or more of the features described herein, the cord is braided or twisted.

In addition to one or more of the features described herein, the sealant is a form-in-place seal.

In addition to one or more of the features described herein, the sealant is urethane.

In addition to one or more of the features described herein, a material of the base portion is different than a material of the cover portion.

In another exemplary embodiment, a method of assembling an electric vehicle battery enclosure includes configuring a base portion to hold one or more batteries that provide motive power to an all-electric or hybrid electric vehicle, and arranging a cover portion to mate with the base portion to enclose the one or more batteries. The method also includes disposing a sealant to create a seal between the base portion and the cover portion around a perimeter of the enclosure, and arranging a cord to break through the sealant to open the enclosure.

In addition to one or more of the features described herein, the method also includes positioning one or more anchor points to anchor the cord to the enclosure.

In addition to one or more of the features described herein, the arranging the cord includes disposing the cord parallel to the sealant and closer to an interior of the base portion than the sealant.

In addition to one or more of the features described herein, the arranging the cord includes extending a portion of the cord outside the enclosure.

In addition to one or more of the features described herein, the arranging the cord includes arranging a nylon wire.

In addition to one or more of the features described herein, the arranging the cord includes arranging a flexible steel wire.

In addition to one or more of the features described herein, the arranging the cord includes arranging a braided or twisted cord.

In addition to one or more of the features described herein, the disposing the sealant includes disposing a wet form-in-place seal.

In addition to one or more of the features described herein, the disposing the sealant includes disposing urethane.

In addition to one or more of the features described herein, the method also includes selecting a different material for the base portion than for the cover portion.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that includes a serviceable electric vehicle battery (EVB) enclosure according to one or more embodiments;

FIG. 2 illustrates a portion of an exemplary serviceable EVB enclosure according to one or more embodiments;

FIG. 3 illustrates an exemplary serviceable EVB enclosure according to one or more embodiments; and

FIG. 4. details an exemplary relative arrangement of the sealant and material of a serviceable EVB enclosure according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, the batteries of an electric or hybrid vehicle (i.e., EVBs) must be protected in a secure enclosure during operation of the vehicle. However, one or more of the batteries or other components in the enclosure may require servicing, which in turn requires breaching the enclosure. Opening the enclosure may be required in order to test or replace one or more batteries or battery components, for example. While the accessibility requirement may suggest latches or other known fasteners or mechanisms, cost, weight, and complexity must be considered, as well. Embodiments of the systems and methods detailed herein relate to a serviceable EVB enclosure. A rigid enclosure includes two parts that are held together with a sealant to keep the EVBs within the enclosure securely in place, to prevent the incursion of debris (e.g., water), and to prevent the escape of gasses and heat. A flexible material (e.g., cord, wire) is disposed along the length of the seal. The material is anchored within the enclosure and is strong enough to break the seal as it is positioned across the seal and pulled along its length (i.e., along the lateral axis).

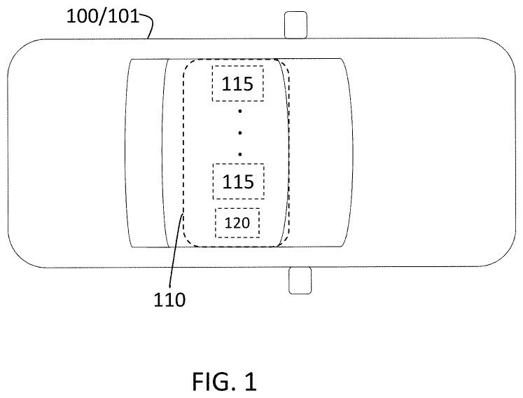

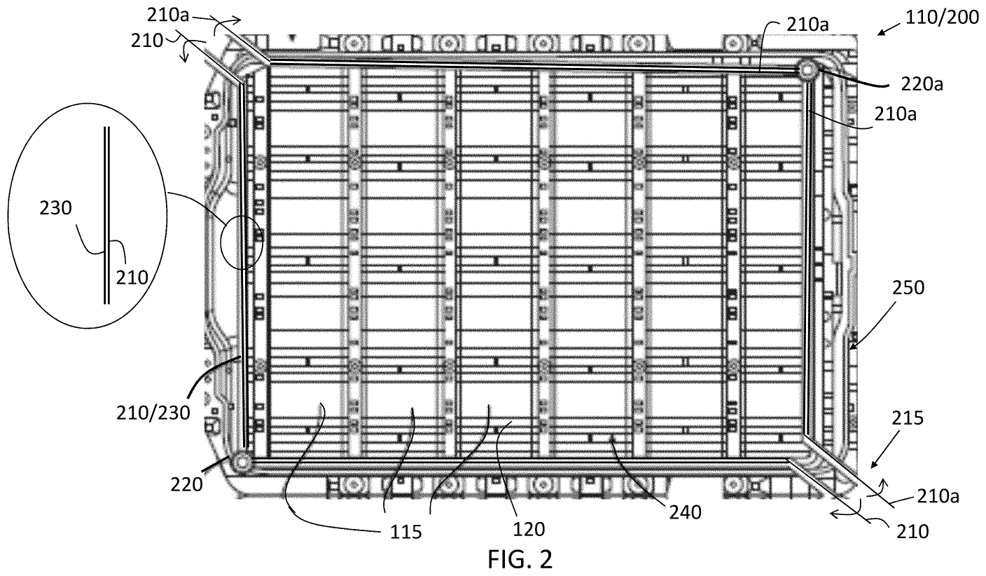

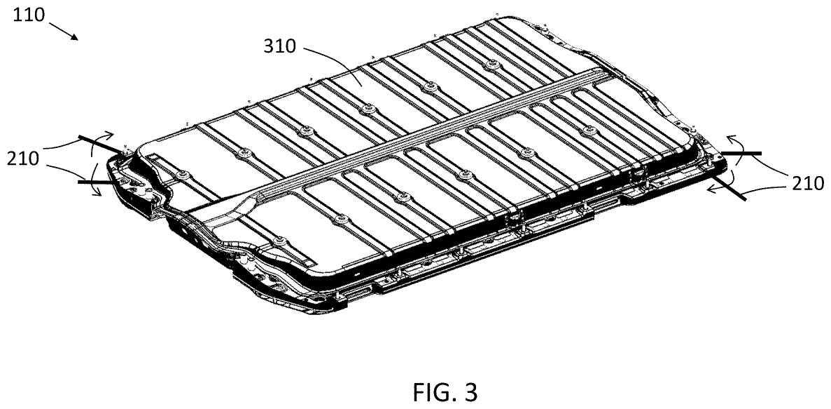

In accordance with an exemplary embodiment, FIG. 1 is a block diagram of a vehicle 100 that includes a serviceable electric vehicle battery enclosure (EVB enclosure) 110. The EVB enclosure 110 includes two or more EVBs 115, as well as other components 120 (e.g., temperature sensor). The vehicle 100 is all-electric or an electric hybrid that derives motive power from the EVBs. The exemplary vehicle 100 shown in FIG. 1 is an automobile 101. Other exemplary vehicles 100 include trucks, construction equipment, farm equipment, and automated factory equipment. The EVB enclosure 110 is further detailed with reference to FIGS. 2 and 3.

Although a generally rectangular shape is indicated in the center portion of the automobile 101, the shape and location of the EVB enclosure 110 is not intended to be limited by the exemplary depiction in FIG. 1. The numbers and arrangements of the EVBs 115 and other components 120 within the EVB enclosure 110 is also not intended to be limited by the exemplary depiction. The vehicle 100 includes may other components that are not shown or detailed herein. For example, the vehicle 100 may include one or more sensors (e.g., radar system, lidar system, camera) that obtain information about the vehicle 100 and its environment. The vehicle 100 may also include controllers that facilitate autonomous or semi-autonomous operation and, additionally, monitor the EVBs 115 and other components 120.

FIG. 2 illustrates a base portion 200 of an exemplary serviceable EVB enclosure 110 according to one or more embodiments. The base portion 200 may have a tray-like shape such that the interior portion 240 is sunken in comparison to the peripheral portion 250. The interior portion 240 may hold a number of EVBs 115 and other components 120. According to one or more embodiments, the base portion 200 of the EVB enclosure 110 is attached to an exemplary cover portion 310 (FIG. 3) with a sealant 230. The sealant 230 is suitable for a form-in-place seal, meaning that the sealant 230 is applied in a wet state and cures to seal the base portion 200 to the cover portion 310. Exemplary sealants 230 include urethane and silicone. The sealant 230 may be disposed along the perimeter of the exemplary base portion 200 to adhere to the cover portion 310. A cord 210 is disposed alongside the sealant 230 but closer to the interior of the exemplary base portion 200 than the sealant 230, as shown in the expanded view.

The cord 210 may twisted or braided or may be a wire, for example. The cord 210 material may be flexible nylon, steel, or another substance with sufficient strength to break the seal of the sealant 230. The cord 210 is anchored to the exemplary base portion 200 at anchor points 220. The anchor points 220 may be screws or the like and may attach the cord 210 to the exemplary base portion 200 or act as a wrap-around post for cord 210 extending on both sides of each anchor point 220. For example, cord 210a may wrap from one side of the anchor point 220a to the other, as indicated. The numbers and placements of the anchor points 220 are not intended to be limited by the illustration in FIG. 2.

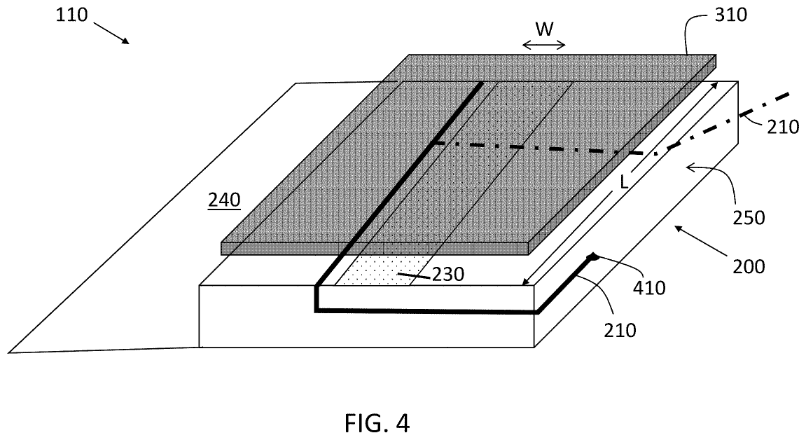

As shown in FIG. 2, the cord 210 extends outside the base portion 200 to be accessible even after the exemplary base portion 200 is sealed with the cover portion 310. While the portion of the cord 210 that extends beyond the exemplary base portion 200 is shown as extending straight out of the exemplary base portion 200 for explanatory purposes, this cord 210 may be adhered to or otherwise attached to the outside of the EVB enclosure 110 to keep the cord 210 accessible but ensure that it is not pulled accidentally. To open the EVB enclosure 110 after the cover portion 310 is attached to the exemplary base portion 200 shown in FIG. 2, each segment of the cord 210 is pulled in the direction indicated by each of the arrows. Because the sealant 230 is between the cord 210 disposed alongside it within the EVB enclosure 110 and the portion of the cord 210 being pulled, the cord 210 that is disposed alongside the sealant 230 will cut across and through the sealant 230 as it is pulled, as further discussed with reference to FIG. 4.

FIG. 3 illustrates an exemplary serviceable EVB enclosure 110 according to one or more embodiments. The cover portion 310 is visible in the view of FIG. 3 while the base portion 200 (FIG. 2) that the cover portion 310 mates with is not visible. The cover portion 310 and base portion 200 may be composed of the same material (e.g., aluminum, steel, fiberglass, carbon) or different materials. The parts of the base portion 200 and cover portion 310 that contact the sealant 230 must comprise a substance that adheres to the sealant 230. Holes or openings in the EVB enclosure 110 to accommodate wiring and connectors from the EVBs 115 and other components 120 to controllers or other parts of the vehicle 100 outside the EVB enclosure 110 are not indicated in the figures. The cord 210 that extends outside the EVB enclosure 110 is shown in FIG. 3. As previously noted, the view of the cord 210 in FIG. 3 is for explanatory purposes. Alternately, the cord 210 may be adhered or attached to an outside of the EVB enclosure 110 to ensure that it is not pulled accidentally. The direction in which each extension of the cord 210 must be pulled to open the EVB enclosure 110 is indicated by the arrows.

FIG. 4 details aspects of the EVB enclosure 110 and, more specifically, the relative arrangement of the sealant 230 and cord 210 according to one or more embodiments. Aspects of the interior portion 240 and peripheral portion 250 of a base portion 200 and cover portion 310 of an exemplary EVB enclosure 110 are shown. The base portion 200 and cover portion 310 are shown separated by a small gap (rather than mated) for explanatory purposes. In the peripheral portion 250, a sealant 230 is shown with a cord 210 arranged along (i.e., parallel to) its length, also referred to as lateral axis or axial length (i.e., along L). The width, or axis perpendicular to the axial length, is indicated as W in FIG. 4. The anchor point 220 (FIG. 2) by which the cord 210 is anchored to the base portion 200 is not shown in the view of FIG. 4. The portion of the cord 210 that extends outside the EVB enclosure 110 is shown affixed to the base portion 200 at an attachment point 410.

To unseal the EVB enclosure 110 and separate the base portion 200 from the cover portion 310, the cord 210 is detached from the attachment point 410. As FIG. 4 indicates, some of the cord 210 that is not arranged along the axial length of the sealant 230 (i.e., along L) is across its width (i.e., along W). The cord 210 is pulled along the axial length L while it is maintained across the sealant 230 (across W) at the same time. An intermediate position is indicated by the dashed representation of the cord 210 in FIG. 4.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. An electric vehicle battery enclosure, the enclosure comprising:
a base portion configured to hold one or more batteries that provide motive power to an all-electric or hybrid electric vehicle;
a cover portion configured to mate with the base portion to enclose the one or more batteries;
a sealant configured to create a seal between the base portion and the cover portion around a perimeter of the enclosure; and
a cord configured to break through the sealant to open the enclosure.

2. The enclosure according to claim 1, further comprising one or more anchor points configured to anchor the cord to the enclosure.

3. The enclosure according to claim 1, wherein the cord is arranged parallel to the sealant and closer to an interior of the base portion than the sealant.

4. The enclosure according to claim 3, wherein a portion of the cord extends outside the enclosure.

5. The enclosure according to claim 1, wherein the cord is a nylon wire.

6. The enclosure according to claim 1, wherein the cord is a flexible steel wire.

7. The enclosure according to claim 1, wherein the cord is braided or twisted.

8. The enclosure according to claim 1, wherein the sealant is a form-in-place seal.

9. The enclosure according to claim 8, wherein the sealant is urethane.

10. The enclosure according to claim 1, wherein a material of the base portion is different than a material of the cover portion.

11. A method of assembling an electric vehicle battery enclosure, the method comprising:
configuring a base portion to hold one or more batteries that provide motive power to an all-electric or hybrid electric vehicle;
arranging a cover portion to mate with the base portion to enclose the one or more batteries;
disposing a sealant to create a seal between the base portion and the cover portion around a perimeter of the enclosure; and
arranging a cord to break through the sealant to open the enclosure.

12. The method according to claim 11, further comprising positioning one or more anchor points to anchor the cord to the enclosure.

13. The method according to claim 11, wherein the arranging the cord includes disposing the cord parallel to the sealant and closer to an interior of the base portion than the sealant.

14. The method according to claim 13, wherein the arranging the cord includes extending a portion of the cord outside the enclosure.

15. The method according to claim 11, wherein the arranging the cord includes arranging a nylon wire.

16. The method according to claim 11, wherein the arranging the cord includes arranging a flexible steel wire.

17. The method according to claim 11, wherein the arranging the cord includes arranging a braided or twisted cord.

18. The method according to claim 11, wherein the disposing the sealant includes disposing a wet form-in-place seal.

19. The method according to claim 18, wherein the disposing the sealant includes disposing urethane.

20. The method according to claim 11, further comprising selecting a different material for the base portion than for the cover portion.
